(19) United States
(12) Patent Application Publication
(10) Pub. No.: US 2009/0241421 A1
(43) Pub. Date: Oct. 1, 2009

(54) Window system with integral mounting base

(75) Inventors: Henry M. Hay, III, Charleston, SC (US); Bruce A. Weber, Summerville, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: The Muhler Company, North Charleston, SC (US)

(21) Appl. No.: 12/079,714

(22) Filed: Mar. 28, 2008

(51) Int. Cl. E06B 3/00

(52) U.S. Cl. 49/57; 49/504; 52/745.15; 52/745.16; 49/506

(57) ABSTRACT

A window system for installation in a structure is provided. The window system includes a front side that faces away from the structure and a back side that faces into the structure when the window system is installed in a structure. The window system further includes at least one window pane having a front side that faces away from the structure and a back side that faces into the structure when the window system is installed in a structure; at least one sash that surrounds the at least one window pane, wherein the sash has a front side that faces away from the structure and a back side that faces into the structure when the window system is installed in a structure; at least one window frame comprising at least one head, sill, and jamb; and at least one mounting base integral to the window.

### BACKGROUND OF THE INVENTION

The present invention relates to a window system with a mounting base integral to the window system, as well as methods for manufacturing such windows and using such windows.

It is often desirable to attach an object to a window. For instance, decorative objects are often desired to be attached to the interior or exterior of a window. Such decorative objects can include window treatments; such as shutters, blinds, or shades; bird feeders; thermostats; rain gauges; wind chimes; wind socks; and flags. In addition, it is often desirable to attach security objects, such as security bars, or safety objects, such as safety bars, to a window.

In addition, because windows are generally the weakest portions of a structure, it is often desirable to protect them from storm conditions and hazards, including wind and wind-borne debris. As such, objects are commonly installed over windows to protect them from such conditions. Absent protection, the windows could suffer damage, including broken glass, which is a potential hazard in storm conditions. In addition, damage to windows can expose a building's interior, and such exposure can result in further damage from wind and rain. Window protection is particularly desirable in coastal areas subject to hurricanes and tropical storms, and particular standards of suitable protection may be locally regulated.

Many current storm protection options have undesirable drawbacks. For instance, some current options are aesthetically unpleasing and require expensive and time-consuming installation, often by professionals. Other options cause damage to the structure upon which the protection is installed. In addition, since a storm can escalate very quickly, leaving structure owners with only a little time to prepare, it is imperative that the owner be capable of quickly installing storm protection objects.

One common option is affixing pieces of plywood over each window. The plywood, however, is often nailed or screwed to the structure or window frame, which leaves holes that must be patched and painted. Similarly, some structure owners place tape over windows, but the tape offers minimal protection and is prone to leave a residue requiring effort to remove.

Another common method of protecting windows from storm conditions involves installing storm panels over the windows. These panels are typically found in elongated sections that can be arranged vertically or horizontally across a window or other opening in a structure. Each panel is typically placed edge-to-edge with other panels to cover an entire opening. The panels may be made of corrugated metal, such as extruded corrugated aluminum.

Storm panels typically are mounted on the exterior wall of a structure. To facilitate installation, tracks to receive and support the panels often are mounted permanently onto a structure's exterior wall surrounding an opening. These tracks require extensive cost and labor to install. In most instances, a professional must visit the structure site and measure the windows. Then, the tracks must be cut to appropriate sizes. Finally, the professional must return the structure site and install the tracks, which are often difficult on multi-level homes. In addition, the tracks are aesthetically unpleasing as permanent fixtures.

### SUMMARY OF THE INVENTION

In one aspect, the present invention is a window system for installation in a structure. The window system includes a front side that faces away from the structure and a back side that faces into the structure when the window system is installed in a structure. The window system further includes at least one window pane having a front side that faces away from the structure and a back side that faces into the structure when the window system is installed in a structure; at least one sash that surrounds the at least one window pane, wherein the sash has a front side that faces away from the structure and a back side that faces into the structure when the window system is installed in a structure; at least one window frame comprising at least one head, sill, and jamb; and at least one mounting base integral to the window.

In another aspect, the present invention is a method for removably mating an attachment to a window system. The method includes the step of removably mating the attachment to a mounting base that is integral to the window system.

In yet another aspect, the present invention is a method for protecting a structure. The method includes the step of removably mating a storm protection apparatus to a window system. In this method, the window system comprises a front side that faces away from a structure when installed and a back side that faces into the structure when installed in a structure; at least one window pane; at least one sash that surrounds the at least one window pane; at least one window frame; and at least one mounting base integral to the window system and capable of removably mating to a protective cover.

In a different aspect, the present invention is a method for manufacturing a window system having a front side and a back side. The method includes mounting at least one window pane within at least one sash; mounting the at least one sash within a window frame; and installing at least one mounting base integral to the window system.

In another aspect, the present invention is a method for retrofitting a window system to engage an attachment. This method includes installing at least one mounting base integral to the window system.

### BRIEF DESCRIPTION OF THE DRAWINGS

FIG. 1 is a perspective view of a double-hung window 100 in a closed position as viewed from the exterior of a home or building.

FIG. 1A shows an anchor, specifically a female PanelMate® anchor, that can be used as a mounting base on a window system.

FIG. 2 is a perspective view of a storm panel that can be attached to a window having an integral mounting base, wherein the integral mounting base facilitates the attachment of the storm panel to the window.

FIG. 3 shows a threaded wingnut that can be used as a connector in attaching an object to a window using the integral mounting base on the window.

FIG. 4 is a perspective view of two storm panels functioning as a single protective cover unit, wherein the two storm panels overlap on one end and have keyhole slots that align with one another when installed.

The following detailed description is to be read with reference to the drawings, in which like elements in different drawings have like reference numbers. The drawings, which are not necessarily to scale, depict selected embodiments and are not intended to limit the scope of the invention.

### DETAILED DESCRIPTION OF THE EMBODIMENTS

In accordance with the present invention, a novel window system has been discovered. The window permits an attachment or multiple attachments to be removably mated to the window in a secure and efficient manner. The novel window system includes at least one integral mounting base.

As used herein, the term “window system” means fixtures that are installed into or over an opening in a structure. By way of example, as used herein, the term window system may include one or more of windows, doors, screens, and the like. The window system may be commercial or residential use. Any type of window system is within the scope of the present invention, including, but not limited to, fixed panel windows, single-hung windows, double-hung windows, casement windows, horizontal slider windows, bay windows, bow windows, fixed windows, tilt windows, tilt-turn windows, rotating windows, jalousie windows, skylights, and the like.

When the opening is described herein as having a length and a width, what is meant is the longitudinal and latitudinal dimensions of the face of the opening. When referring to an opening on a vertical wall, the length of the opening is the vertical dimension of the opening and the width is the horizontal dimension of the opening.

The present window systems may be installed to protect an opening in any type of structure. For example, the structure can be a one or multi-story building. Additionally, the structure may be a commercial or residential structure.

The window system of the present invention generally comprises a front side and a back side, wherein, when installed in a structure, the front side generally is on the exterior of the structure and the back side generally is on the interior of the structure. The window system generally further comprises at least one window pane, sash, head, sill, jamb, and window frame, each of which includes a front side and back side that corresponds to the front side and back side of the window system.

The sash, head, sill, jamb, and window frame can be constructed of any known window building material or combination of materials, such as wood, composite, and/or vinyl. In particular embodiments, the window system may also include other components, such as rails and latches. The window system can be manufactured as described herein or can be a commercially available window that is subsequently configured as described herein.

When installed in a structure, a window pane generally has a front side that faces the exterior of a structure and an opposing back side that faces the interior of a structure. The present invention contemplates any number of window panes of any size and shape. In addition, a single window may have multiple panes wherein the panes differ in size and/or shape. A window pane can be transparent or translucent, and it can be composed of any material commonly used in the industry, including glass, plastic, laminate, or any combination thereof. Additionally, the window system may include a single pane and/or a multi-pane design, in which at least two panes constitute a first pane and a second pane each of which is opposite and parallel to and spaced apart from the other.

It is further contemplated that the window panes of the present invention can include additional features, such as features for energy efficiency and/or impact resistance. For instance, the window panes may include a film or polymer for increased impact resistance, such as disclosed in patent application Ser. No. 12/070687, which is incorporated herein by reference. In addition, a gas may be present between the window panes of a multi-pane window system, or low-e glass may be used, to improve energy efficiency.

The window system of the present invention further includes a mounting base that is integral to the window system and facilitates removably mating an attachment to the window. As used herein, “integral” means that the mounting base is a component of the window, but it is not required that a component be formed at the time of manufacture of the window. That is, to be considered integral in the context of the current invention, a component can be manufactured as a part of the window, such as during extrusion, or it can be attached to a window at any point after the window is manufactured. In a preferred embodiment, the mounting base is manufactured as a part of the window.

The terms “mate” and “mating,” as used herein, mean to attach, either directly or indirectly, the window system to an attachment. When an object is indirectly mated with an attachment, the window system need not directly contact the attachment to mate with it but instead can be mated to the attachment by way of a connector.

The mounting base can be of any type, wherein “type” when used with reference to a mounting base means the hardware comprising the integral mounting base. For instance, types of mounting bases can include any hardware that facilitates removably attaching an object to the window, such as an anchor, such as a PanelMate® anchor, a bolt, such as a mushroom bolt, a hole or threaded hole, threaded lugs or studs, keyhole slots or other slots, a nut, and other suitable hardware known to those of ordinary skill in the art. A mounting base can be configured as a male or female hardware component, or both. It is understood that a window system can comprise a single type of mounting base or multiple types of mounting bases, and a window system with any quantity and type of mounting bases is within the scope of the present invention.

In some embodiments, it may be preferred that the mounting base be formed of a corrosion resistant material.

In some embodiments of the present invention, a supplement or multiple supplements are inserted into the window system, such as in the hollow area inside of a window frame, to further secure the mounting base to the window system. The supplement can be a solid, such as a synthetic deck board, or a liquid, paste, and/or foam that will harden and secure the mounting base. It is preferred that the solid, liquid, paste, and/or foam does not reach a curing temperature that will distort or react unfavorably when in contact the window or its components. In other embodiments, the mounting base may be secured by extending through the window frame or sash, such as when a bolt is inserted into one face of the window frame and protrudes through the window frame and out the opposing face of the window frame.

A mounting base can be located on the window frame, such as on a head, a sill, and/or a jamb. In other embodiments, a mounting base is alternatively or additionally located on any sash or on multiple sashes of the window. In addition, a mounting base can be located on the front side of the window system and/or on the back side of the window system.

The present invention can comprise any number of mounting bases and the mounting bases can be in any configuration. For instance, a window can have any number of mounting bases that are positioned at any location or combination of locations on a window.

In some embodiments, the mounting bases may be located along a top edge of the window system. In other embodiments, the mounting bases may be located along a bottom edge of the window system. In yet other embodiments, the mounting bases may be located along one or both sides of the window system. It may be desirable to have mounting bases along both the top and bottom edges of the window system, along both sides of the window system, or both. Additionally, it may be desirable to have mounting bases located along either the top or bottom of the window system and on one side of the window system. The mounting bases can further be in any configuration, and the window can further include any combination of types of mounting bases.

Furthermore, any quantity and/or configuration of mounting bases alternatively could be used in accordance with the present invention. Mounting bases could additionally or alternatively be placed on any of the window portions described above on either the front or back side of the window system. Thus, it is appreciated that the quantity, types, configuration, and location of mounting bases can be varied within the scope of the current invention.

It will further be understood that a larger quantity of mounting bases may be desirable on window systems designed to be installed in large openings than will be required on window systems designed to be installed in smaller openings.

The present invention contemplates the mounting base facilitating the mating of an attachment to the window system. By way of example, one attachment that can be mated to the window system by use of a mounting base is a storm protection panel, such as commercially available corrugated steel, aluminum, or LEXAN® storm panels, manufactured, for example, by GE plastics, or fabric storm panels, such as Fabric-Shield™ storm panels, manufactured, for example, by Wayne-Dalton, a roll-down material, such as Storm-a-Rest™ hurricane curtains, manufactured, for example, by Honeywell, a screen, plywood, storm shutters, or any other storm protection object.

Other attachments that a user may desire to mate to the window system by utilizing the at least one mounting base may include decorative items, such as, but not limited to interior or exterior shutters and/or window treatments, such as blinds, shades, and curtains. Other decorative attachments contemplated in accordance with the present invention may include one or more of bird feeders, thermostats, rain gauges, wind chimes, wind socks, and flags. Other contemplated attachments may include security apparatus, such as security bars, and/or safety apparatus, such as bars to prevent children from accidentally falling out of the structure through the window system.

In some embodiments, an attachment is directly attached to the mounting base of the window system. In other embodiments, a connector is used to mate the attachment to the mounting base of the window system. A “connector” means any component that is used in mating an attachment to the mounting base, such as by attaching or securing or fastening. A connector can include, by way of example, pintles for attaching shutters, blind hangers for attaching blinds, or bolts, such as mushroom bolts, screws, wingnuts, threaded bolts, nuts, pins, and other hardware known to those of ordinary skill in the art for mating. A connector can include male or female hardware, both male and female hardware, or neither. Connectors may comprise corrosion resistant materials.

Reference now will be made in detail to some embodiments of the invention. Each embodiment is provided by way of explanation of the invention and not as a limitation of the invention or the broader aspects of the invention. It will be apparent to those of ordinary skill in the art that various modifications and variations can be made in the present invention without departing from the scope or spirit of the invention. For instance, features illustrated or described as part of one embodiment can be used on another embodiment to yield a further embodiment. It is intended that the present invention covers such modifications and variations that come within the scope of the appended claims and their equivalents. In addition, other objects, features, and aspects of the present invention are disclosed in or are obvious from the following detailed description.

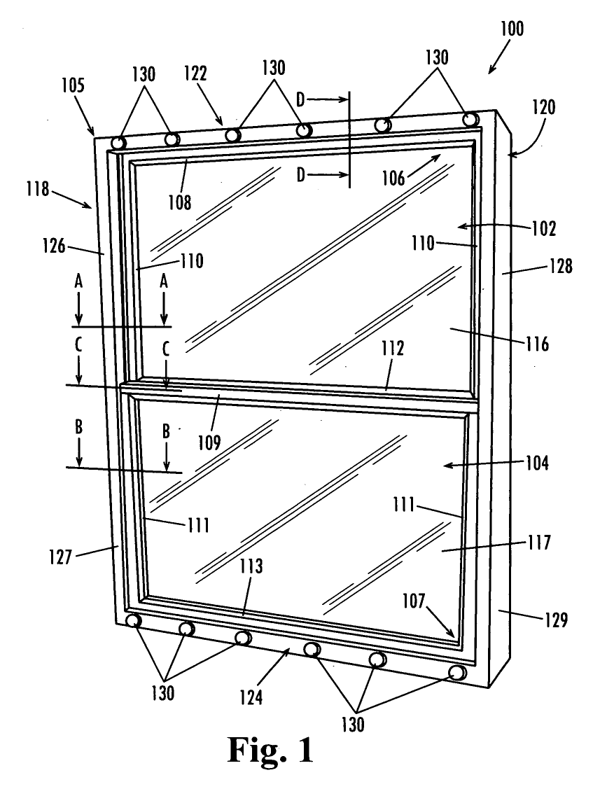

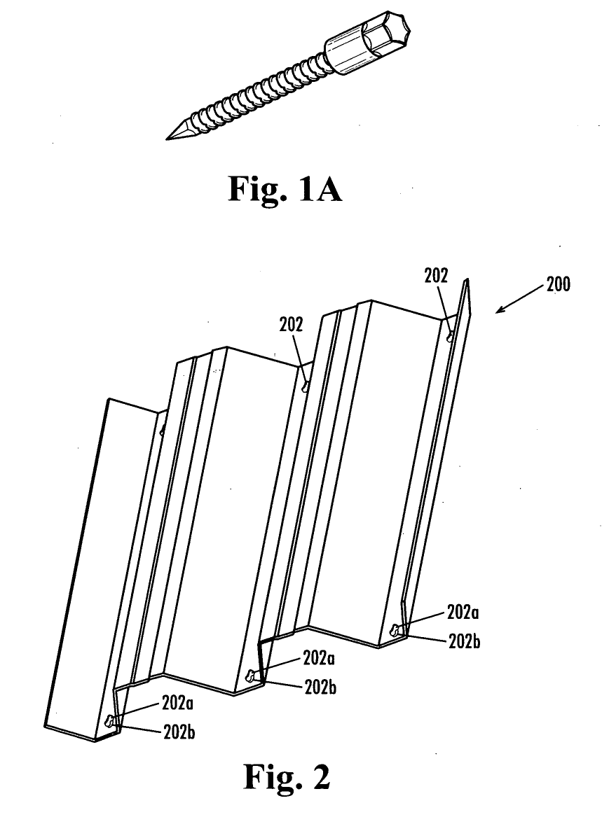

FIG. 1 shows one embodiment of the present invention. FIG. 1 is a perspective view of a double-hung window 100 in a closed position as viewed from the exterior of a home or building. The double-hung window 100 has an upper sash 102 and a lower sash 104. Surrounding the upper sash is an inner frame 106 comprising a top rail 108, side rails 110, and bottom rail 112 that hold the upper sash pane 116 in place. Surrounding the lower sash is a inner frame 107 comprising a top rail 109, side rails 111, and bottom rail 113 that hold the lower sash pane 117 in place. The inner frames 106,107 can be constructed of any known window building material, such as wood or vinyl. When the double-hung window 100 is in the closed position as shown in FIG. 1, upper sash 102 and lower sash 104 meet at a check rail 114.

Outer window frame 105 surrounds the upper sash 102 and lower sash 104 and secures them within the double-hung window 100. Outer window frame 105 has a first side jamb 118, second side jamb 120 head jamb 122, and sill 124. The first side jamb 118 has an upper portion 126 and a lower portion 127. The second side jamb 120 has an upper portion 128 and a lower portion 129. When the window is closed, the top rail 108 of the upper sash 102 sealably contacts the head jamb 122. In the closed position, the bottom rail 113 of the lower sash 104 sealably contacts the sill 124. In the closed position, there are no openings from the interior to the exterior of the double-hung window 100. When the double-hung window 100 is in the closed position, a portion of the upper first side jamb 126 and upper second side jamb 128 is visible from the interior of the window 100.

Integral to the window 100 is at least one mounting base 130. In FIG. 1, multiple mounting bases 130 are shown integral to the head jamb 122 and the sill 124 of window 100. The mounting bases 130 depicted in this embodiment are female anchors, specifically those called PanelMate® anchors, manufactured by, for example, Cutler-Hammer, that are shown in more detail in FIG. 1A. The mounting bases 130 can be further secured by injecting or inserting a solid, liquid, paste, and/or foam into the outer window frame 105.

From the description above, it will be understood by those having ordinary skill in the art that other types of mounting bases can be used in the present invention, either in addition to or in lieu of the illustrated mounting bases. In addition, additional or alternative mounting bases could be located on the first side jamb 118, second side jamb 120, upper sash 102, and/or lower sash 104. As previously discussed, any configuration or quantity of mounting bases integral to the window system are contemplated in accordance with the present invention.

As considered in conjunction with FIG. 1, the storm panel 200 depicted in FIG. 2 illustrates another embodiment of the current invention. The storm panel 200 depicted in FIG. 2 is representative of a commercially available storm panel, which is generally constructed of corrugated metal such as aluminum. The storm panel 200 is capable of being removably mated to the window system 100 and the mating is facilitated by at least one mounting base 130 integral to the window system 100. When installed, the storm panel 200 shields the window system 100 and the interior of the structure on which the window system 100 is installed from inclement weather and wind-borne debris. The storm panel 200 includes keyhole slots 202, which have an upper portion 202a that is narrower in width than the lower portion 202b.

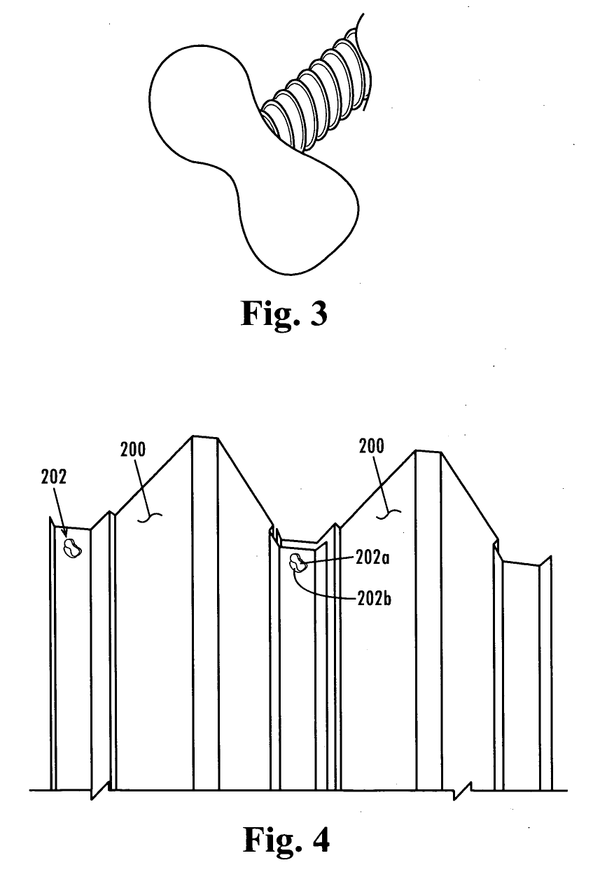

The storm panel 200 depicted in FIG. 2 can be removably mated to the window system 100 illustrated in FIG. 1 by utilizing the integral mounting base 130 of the present invention. In one embodiment, to attach the storm panel 200 to the window system 100, at least one keyhole slot 202 of the storm panel 200 is aligned with at least one mounting base 130 of the window system 100. A connector 300 may then be inserted through the at least one keyhole slot 202, either through the upper portion 202a or the lower portion 202b, and into the at least one mounting base 130. One embodiment of a connector 300 is depicted in FIG. 3 as a threaded wing nut. Other connectors 300 could similarly be used in the depicted embodiment, such as screws, bolts, and other hardware known to one of ordinary skill in the art.

In some embodiments of the present invention, multiple storm panels 200 are mated to single window system 100. In some embodiments using multiple storm panels 200, 204, the keyhole slots 202, 206 on more than one protective cover can be mated to a single mounting base 130 on the window system 100. For instance, as shown in FIG. 4, the edge of a first storm panel 200 and the edge of a second storm panel 204 can be overlayed such that a keyhole slot 202 of the first storm panel 200 and a keyhole slot 206 of the second storm panel 204 are aligned. When mated to the window system 100, these aligned keyhole slots 202, 206 are mated to the same mounting base 130 of the window system 100. If necessary, a single fastener 300 can be used in conjunction with the mounting base 130, or multiple fasteners 300 can be used. This overlapping allows multiple storm panels 200, 204 to function as a single unit. Alternatively, a second storm panel 204 can be installed alongside a first storm panel 200 on the window 100 without any overlapping or sharing of an integral mounting base 130.

Another alternative embodiment contemplated by FIGS. 1 and 2 is the use of a mushroom bolt as a connector. In such an embodiment, the attached storm panel 200 can be hung on the mushroom bolt serving as a connector. With reference to FIGS. 1 and 2, an embodiment using a mushroom bolt as a connector 300 would require inserting and securing the mushroom bolt in the mounting base 130. The storm panel 200 could then be mated to the mushroom bolt by aligning the lower portion 202b over the fastener 300. The mushroom bolt serving as connector 300 is then inserted through lower portion 202b of the storm panel 200, and the storm panel 200 is then pulled in a downward direction such that the upper portion 202a of the keyhole slot 202 is engaged with the connector 300.

In yet additional embodiments, a mushroom bolt or other hardware can be integrally formed as part of the window or integrally attached directly to the window system 100, without a female PanelMate® anchor or other hardware. In such embodiments, the mushroom bolt or other attached hardware would itself function as a mounting base 130. In such an embodiment, the storm panel 200 would be attached as described above, with the mushroom bolt or other integral hardware functioning as the mounting base 130 as opposed to a connector. Thus, the present invention contemplates that certain hardware can serve as a connector 300 in some embodiments and as a mounting base 130 in other embodiments.

In another aspect, the present invention includes methods for removably mating an object to a window system. The methods provide a simple and convenient manner of removably mating an attachment to a window system. In addition to convenience, the method can provide a manner of quick mating that is often essential, such as mating storm protection apparatus to a window system when storm conditions are present or imminent.

These methods are practiced by removably mating an attachment to a window system by use of at least one mounting base integral to the window system. In some embodiments, the attachment is directly mated with the mounting base, whereas in other embodiments a connector may be utilized to removably mate the attachment to the window system. In some embodiments using a connector, the connector will be mated to the mounting base before the attachment is mated, whereas this order will be reversed in other embodiments such that the connector is mated to the mounting system after the attachment is mated to the connector. Under this method, an attachment can be mated to the front and/or back side of the window.

For instance, as described above with regard to an embodiment using a mushroom bolt as a mounting base 130 and a storm panel 200 with keyhole slots as the attachment, the storm panel 200 is directly mated to the mounting base 130. By contrast, a connector 300 is engaged with the mounting base 130 to mate the storm panel 200 to the window system 100 in the embodiment described above in which a PanelMate® anchor serves as the mounting base 130 and a mushroom bolt is used as the connector 300. Similarly, a male wingnut may used as a connector 300 in another embodiment described above. These descriptions are illustrative only and one of ordinary skill in the art will appreciate alternative embodiments from these examples.

In yet another aspect, the present invention includes methods for manufacturing a window system with at least one mounting base integral to the window system and for retrofitting an existing window to include at least one mounting base integral to the window system.

To manufacture a window system of the current invention, at least one window pane is mounted and secured within at least one window sash, wherein the sash surrounds the entire window pane. At least one integral mounting base is integrally formed or installed onto the window frame and/or sash, and the integral mounting base can be installed on the front side and/or the back side of the window. The mounting base can be created during extrusion or it can subsequently be mounted by any conventional means, such as drilling, hammering, soldering, welding, screwing, or other like means.

Existing windows can be retrofitted by installing at least one mounting base integral to window frame and/or window sash of the existing window. The existing window can be retrofitted before or after being installed within a structure, and the mounting base can be installed on the front side or the back side of an installed window system. The mounting base can be installed into an existing window system by any conventional means, such as drilling, hammering, soldering, welding, screwing, or other like means.

Additional steps may be taken in certain embodiments of manufacturing a window system with a mounting base or retrofitting an existing window system to include a mounting base. In some embodiments, a solid, liquid, paste, and/or foam is inserted or injected or otherwise provided in the interior of the window frame to further secure the mounting base to the window system. In other embodiments, the mounting base is installed to extend through the entire window frame or sash.

It is to be understood that the present invention is not limited to windows, and the invention further encompasses other openings in structures, such as doors and the like.

The present invention eliminates the necessity of attaching devices, such as storm panels, directly to structures. By eliminating this method of attachment, the aesthetic integrity of the structure is maintained due to the elimination of unsightly mounting tracks or devices for storing rolled hurricane shutters. Additionally, no holes are made in the structure surface, maintaining the physical integrity of the structure coverings, such as vinyl siding, hardy plank siding, wood, brick, stucco, or other known structural coverings.

As various changes could be made in the above embodiments and descriptions by those of ordinary skill in the art without departing from the scope of the invention, it is intended that all matter contained in the above description and shown in the accompanying drawings shall be interpreted as illustrative and not in a limiting sense. Skilled artisans will recognize that the given examples have many alternatives that fall within the scope of the invention. In addition, it should be understood that aspects of the various embodiments may be interchanged in whole or in part.

What is claimed is:

1. A window system for installation in a structure, the window system having a front side that faces away from the structure and a back side that faces into the structure when the window system is installed in a structure, the window system comprising:
at least one window pane having a front side that faces away from the structure and a back side that faces into the structure when the window system is installed in a structure;
at least one sash that surrounds the at least one window pane, wherein the sash has a front side that faces away from the structure and a back side that faces into the structure when the window system is installed in a structure;
at least one window frame comprising at least one head, sill, and jamb; and
at least one mounting base integral to the window system.

2. The window system of claim 1 wherein the at least one mounting base is located on the window frame.

3. The window system of claim 2 wherein the at least one mounting base is located on the head, sill, and/or jamb of the window system.

4. The window system of claim 1 wherein the at least one mounting base is located on at least one sash of the window.

5. The window system of claim 1 further comprising at least one connector in communication with the attachment to removably mate the attachment to the mounting base.

6. The window system of claim 5 wherein the at least one connector is selected from the group consisting of pintles, blind hangers, bolts, screws, nuts, wingnuts, threaded bolts, pins, and combinations thereof.

7. The window system of claim 1 wherein the at least one mounting base is selected from the group consisting of anchors, bolts, holes, threaded holes, threaded lugs or studs, keyhole slots, other slots, nuts, and combinations thereof.

8. The window system of claim 1 wherein the mounting base is a threaded anchor.

9. The window system of claim 1 wherein the mounting base is located on the front side of the window system.

10. The window system of claim 1 wherein the mounting base is located on the back side of the window system.

11. The window system of claim 1 wherein the mounting base is a female threaded anchor and a connector is used to removably mate an attachment to the mounting base.

12. The window system of claim 11 wherein the attachment is selected from the group consisting of storm panels, storm shutters, blinds, and combinations thereof.

13. The window system of claim 12 wherein the connector is selected from the group consisting of pintles, blind hangers, bolts, screws, nuts, wingnuts, threaded bolts, pins, and combinations thereof.

14. The window system of claim 1 wherein at least a first mounting base is located on the head and at least a second mounting base is located on the sill, wherein the first and second mounting bases are on the same side of the window system.

15. The window system of claim 1 wherein the at least one mounting base is located on at least one jamb.

16. The window system of claim 15 wherein at least a first mounting base is located on a first jamb adjacent a second jamb having at least a second mounting base thereon.

17. The window system of claim 1 comprising more than one mounting base, wherein each mounting base is independently selected from the group consisting of anchors, bolts, holes, threaded holes, threaded lugs or studs, keyhole slots, other slots, nuts, and combinations thereof.

18. The window system of claim 1 wherein the mounting base is secured to the window system by one or more of a paste, solid, foam, liquid, and combinations thereof.

19. A method for removably mating an attachment to a window system, the method comprising removably mating the attachment to a mounting base that is integral to the window system.

20. The method of claim 19 wherein the window system comprises at least one mounting base located on a window frame of the window system.

21. The method of claim 20 wherein the window system comprises at least one mounting base located on a system head, sill, and/or jamb.

22. The method of claim 19 wherein the window system comprises at least one mounting base located on at least one sash of the window system.

23. The method of claim 19 wherein the method further comprises installing at least one connector in communication with the attachment to removably mate the attachment to the mounting base.

24. The method of claim 23 wherein the at least one connector is selected from the group consisting of pintles, blind hangers, bolts, screws, nuts, wingnuts, threaded bolts, pins, and combinations thereof.

25. The method of claim 19 wherein the at least one mounting base is selected from the group consisting of anchors, bolts, holes, threaded holes, threaded lugs or studs, keyhole slots, other slots, nuts, and combinations thereof.

26. The method of claim 19 wherein the mounting base is a female threaded anchor and a connector is used to removably mate the attachment to the mounting base.

27. The method of claim 19 wherein the attachment is selected from the group consisting of storm panels, storm shutters, blinds, and combinations thereof.

28. The method of claim 19 wherein the attachment is removably mated with at least a first mounting base located on the head and at least a second mounting base located on the sill, wherein the first and second mounting bases are on the same side of the window system.

29. The method of claim 19 wherein at least one mounting base is located on at least one jamb.

30. The method of claim 30 wherein at least a first mounting base is located on a first jamb adjacent a second jamb having at least a second mounting base thereon.

31. The method of claim 19 wherein the window system comprises more than one mounting base, wherein each mounting base is independently selected from the group consisting of anchors, bolts, holes, threaded holes, threaded lugs or studs, keyhole slots, other slots, nuts, and combinations thereof.

32. The method of claim 19 comprising wherein the mounting base is secured to the window system by one or more of a paste, solid, foam, and liquid located inside one or more of a sash, sill, frame or jamb of the window system.

33. A method for protecting a structure, the method comprising: removably mating a storm protection apparatus to a window system, wherein the window system comprises:
a front side that faces away from a structure when installed and a back side that faces into the structure when installed in a structure;
at least one window pane;
at least one sash that surrounds the at least one window pane;
at least one window frame; and
at least one mounting base integral to the window system and capable of removably mating to a protective cover.

34. The method of claim 33 wherein the at least one mounting base is located on the window frame.

35. The method of claim 34 wherein the at least one mounting base is located on the head, sill, and/or jamb of the window frame.

36. The method of claim 33 wherein the at least one mounting base is located on at least one sash of the window.

37. The method of claim 33 further comprising the step of temporarily installing at least one connector that, when installed, is in communication with the storm protection apparatus and removably mates the attachment to the mounting base.

38. The method of claim 33 wherein the mounting base is located on the front side of the window system.

39. The method of claim 33 wherein the mounting base is located on the back side of the window system.

40. The method of claim 33 wherein the storm protection apparatus is selected from the group consisting of storm panels, storm shutters, and combinations thereof.

41. The method of claim 33 wherein the storm protection apparatus is removably mated to first and second mounting bases.

42. The method of claim 41 wherein an independent connector is engaged with each of the first and second mounting bases.

43. The method of claim 33 wherein the storm protection apparatus is removably mated to the mounting bases located on a first and second jamb.

44. The method of claim 33 comprising more than one mounting base, wherein each mounting base is independently selected from the group consisting of anchors, bolts, holes, threaded holes, threaded lugs or studs, keyhole slots, other slots, nuts, and combinations thereof.

45. The method of claim 33 wherein the mounting base is secured to the window system by one or more of a paste, solid, foam, liquid, and any combination thereof inside one or more of a window sill, jamb, sash, or frame.

46. A method for manufacturing a window system, wherein the window system has a front side and a back side, the method comprising:
mounting at least one window pane within at least one sash;
mounting the at least one sash within a window frame; and
installing at least one mounting base integral to the window system.

47. The method of claim 46 wherein the at least one mounting base is installed on one or more of the window frame, the sash, a head, a sill, or a jamb of the window system.

48. The method of claim 46 wherein the at least one mounting base is selected from the group consisting of anchors, bolts, holes, threaded holes, threaded lugs or studs, keyhole slots, other slots, nuts, and combinations thereof.

49. The method of claim 46 wherein the at least one mounting base is installed on the front side of the window system.

50. The method of claim 46 wherein the at least one mounting base is installed on the back side of the window system.

51. The method of claim 46 comprising installing more than one mounting base, wherein each mounting base is independently selected from the group consisting of anchors, bolts, holes, threaded holes, threaded lugs or studs, keyhole slots, other slots, nuts, and combinations thereof.

52. The method of claim 46 wherein the method further comprises injecting into a hollow of the window frame of the window frame at least one or more of a paste, solid, foam, liquid, and any combination thereof.

53. A method for retrofitting a window system to engage an attachment, the method comprising installing at least one mounting base integral to the window system.

54. The method of claim 53 wherein the at least one mounting base is installed on one or more of a window frame, window sash, head, sill, or jamb of the window system.

55. The method of claim 53 comprising more than one mounting base, wherein each mounting base is independently selected from the group consisting of an anchor, bolt, hole, threaded hole, threaded lugs or studs, keyhole slots, other slots, a nut, and combinations thereof.

56. The method of claim 75 wherein the method further comprises injecting into a hollow of the window frame of the window frame at least one or more of a paste, solid, foam, liquid, and any combination thereof.
